(19) United States
(12) Patent Application Publication
(10) Pub. No.: US 2026/0326995 A1
(43) Pub. Date: Oct. 22, 2026

(54) A FOLDABLE SOLID CELLULOSE FOAM

(71) Applicant: Stora Enso OYJ, Helsinki (FI)

(72) Inventors: Mari Sumuranta, Vaasa (FI); Kristine Biteniece, Riga (LV); Liga Viksne, Jelgavas novads (LV); Erlands Celmins, Riga (LV); Stuart Roberts, Kettering (GB)

(73) Assignee: Stora Enso OYJ, Helsinki (FI)

(21) Appl. No.: 19/114,131

(22) PCT Filed: Sep. 22, 2023
(86) PCT No.: PCT/IB2023/059378

§ 371 Date: Mar. 21, 2025

(30) Foreign Application Priority Data
Sep. 23, 2022 (SE) 2230306-9
Jun. 21, 2023 (SE) 2330294-6

(51) Int. Cl. B65D 81/107; B26D 3/00; B26D 3/08; C08J 9/00

(52) U.S. Cl. CPC B65D 81/107; B26D 3/006; B26D 3/08; C08J 9/0004; B65D 2581/055; C08J 2301/02

(57) ABSTRACT

A foldable solid cellulose foam wherein said foldable solid cellulose foam comprising an upper surface and a lower surface; wherein at least one of said upper surface and said lower surface of said foldable solid cellulose foam comprising at least one cutting line of a predetermined depth of cut DC; wherein said at least one cutting line is arranged to partially cut through said cellulose foam. The invention also provides a method for producing a foldable solid cellulose foam.

### FIELD OF THE INVENTION

The present invention relates to the area of cellulose foam for packaging, more specifically to a foldable solid cellulose foam.

The invention further relates to a method for producing a foldable solid cellulose foam.

### BACKGROUND INFORMATION

Plastic packaging materials such as fossil-based foams seem increasingly outdated in a society that is striving to reduce plastic usage and waste and move towards renewable materials. With regulatory bodies now driving policy towards limiting or banning fossil-based foam materials in packaging, new solutions are needed.

There are many challenges with finding foams from renewable sources. Many bio-based foams have higher cost of production and lower mechanical performance, as well as poor stability in water or high temperatures, compared to established foams from petroleum-based sources. Bio-based and recyclable protective materials need to have the same excellent characteristics and properties as petroleum-based protective materials for being the first choice over petroleum-based materials.

Low weight and good shock absorption of the bio-based foams are examples of crucial characteristics. Also, the ability to customize the shape and the form of the bio-based foams to the shape and form of the goods to be sheltered by the protective material is of uttermost importance. Cellulose has shown to have a special potential, as the most abundant renewable natural polymer on earth, with its crystalline structure, and the availability of methods for preparing large volumes on an industrial scale.

Several biobased foams comprising cellulose have been described. WO20200011587 A1 describes a porous material that is prepared by aerating a paste comprising cellulose fibres and gluten and depositing the aerated paste in a mould where it is dried. WO2015036659 A1 describes a moulded fibrous product prepared by foaming an aqueous suspension of natural fibres in combination with synthetic fibres and surfactant, feeding the fibrous foam to a mould where it is dried to produce a dry fibrous product.

In packaging applications, the goods to be sheltered may often have protruding portions, e.g. corners and edges, or have complex three-dimensional (3D) shapes that need extra protection by the packaging material during storage and transportation. In addition, the goods may be made of sensitive materials such as glass or porcelain, that need protection because of their fragile nature. Solid cellulose foams may be an interesting alternative in such applications. However, the solid cellulose foams on the market do most often not provide the necessary protection of protruding portions, e.g. corners and edges, or complex 3D shapes due to the rigidity, inflexibility and stiffness of the bio-based foams. It is often not possible to bend or fold solid foams around objects without the bio-based foams cracking and breaking.

There still exists a need for solid cellulose foams that can be tailored around goods of any shape and protect every part of the goods. The goods need to be so well sheltered so that any shock arising during storage and transportation will be absorbed by the surrounding cellulose foam and whereby the shock will not damage the goods.

Also, the solid cellulose foams need to be renewable, biodegradable, and fully recyclable in regular paper and board flows allowing them to be part of a circular material flow in existing packaging waste management systems. Production costs of producing the foams as well as tailoring shapes of the foams to any product shape have to be moderate in order to be a competitive choice.

In order to save raw materials there is also a need for reducing the amount of protective material used in protective packaging, as well as to minimize waste material.

There further exists a need for protective packaging materials that easily can be transported to places where goods are to be packed inside the protective packaging materials. The protective packaging materials need to offer three-dimensionally tailored protection of the goods but also take up as little space as possible during transport to the packaging places.

### SUMMARY OF THE INVENTION

It is an object of the present invention to obviate at least some of the disadvantages in the prior art and to provide a foldable solid cellulose foam.

Thanks to a solution as defined in claim 1 wherein a foldable solid cellulose foam comprises an upper surface and a lower surface and wherein at least one of said upper surface and said lower surface of said foldable solid cellulose foam comprises at least one cutting line of a predetermined depth of cut DC, and wherein said at least one cutting line is arranged to partially cut through said cellulose foam, said foldable solid cellulose foam is provided with at least one hinge for said cellulose foam to be folded around such that said foam may be easily folded around angular shapes, such as corners and edges, of goods to be protected thereby providing cushioning for the goods.

Another advantage is that said foldable solid cellulose foam is a flat material taking up very little space when stored or during transport to the place of use. Still—thanks to the possibility to fold the solid cellulose foam—said foam can be tailored around three-dimensional objects, even of complex shapes, and protect the objects due to the cushioning properties of said foam.

Another advantage is that a predetermined depth of cut is less than a thickness of said cellulose foam and arranged in a direction of said thickness, thereby allowing said foam to remain in one piece. No waste material is cut way.

Yet another advantage is that a direction of cut into said foam is chosen depending on the shape of the goods to be sheltered by said foam meaning that there are very good possibilities to tailor the shape of the foldable foam to the shape of the goods.

Another advantage is that said at least one cutting line may be a straight cutting line, a curved cutting line, an angled cutting line comprising at least one angle, a cutting line of an irregular shape, or any combination thereof again meaning that there are very good possibilities to tailor the shape of the foldable foam to the shape of the goods.

Still another advantage is that said at least one cutting line may be arranged to comprise at least one portion having a predetermined depth of cut that is less than said thickness of said cellulose foam and at least one portion having a predetermined depth of cut that is equal to said thickness of said cellulose foam. A portion having a predetermined depth of cut equal to said thickness of said cellulose foam means that said cutting line portion cuts completely through the foam which may provide the foam with numerous design opportunities. For example, through-cuts provide the cellulose foam with portions that may be taken away thereby leaving voids that may contribute to a housing for enclosing the goods.

The method for producing said flexible solid cellulose foam is cost-effective to implement in existing production lines.

The method may further lead to cheaper and easier manufacture and improved product quality.

The present method is also easy to perform in a large scale set up.

Further aspects and embodiments are defined in the appended claims, which are specifically incorporated herein by reference.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

The invention will be described in more detail with reference to the enclosed figures, in which:

FIG. 1a-1b show a solid cellulose-based foam in a respective unfolded and folded state, and

FIG. 2a-2c show different views of an unfolded and a folded solid cellulose-based foam.

### DETAILED AND EXEMPLIFYING DESCRIPTION OF THE INVENTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

“Plank” as used herein denotes an object that is flat and having an upper surface and a lower surface. Most often, said surfaces are parallel surfaces meaning that said plank has a uniform, or at least substantially uniform, thickness.

“Flexible” as used herein means curvable, stretchable, twistable, bendable and/or foldable.

“Flexible material” as used herein denotes a material that may be curved, stretched, twisted, bent and/or folded. A difference between folding and bending is that folding has a sharp angle occurring within a narrow hinge area; but bending is a global deformation that results in a smoother curvature. Folding may be interpreted as a well-defined and precise form of bending, occurring around a folding axis.

“Rigid” as is used herein means inflexible. A material that is rigid cannot be curved, stretched, twisted, bent and/or folded without cracking and/or breaking into pieces.

“Predetermined depth of cut” as is used herein means that a depth of a cut is determined in advance before arranging or performing said cut.

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface active component, must be present to decrease surface tension. Finally, the foam must form more quickly than it breaks down.

The term “cellulose foam”, as used herein, refers to a foam comprising cellulose, and other components such as thickeners, surfactants and additives. The main component of the cellulose foam is cellulose, such that cellulose constitutes at least 70 wt % of the dry content of the cellulose foam. Cellulose is in the form of fibres, and the foam can thus also be defined to be a fibrous foam or a cellulose fibre foam. The cellulose foam may be wet or solid.

The term “wet foam”, or “wet cellulose foam”, as used herein, refers to a wet foam comprising cellulose, and other components such as thickeners, surfactants and additives. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “solid cellulose foam”, or “dry cellulose foam”, as used herein, refers to a dry porous cellulose material that has been formed from a wet cellulose foam, i.e. a foam formed material. During the drying process, a closed wet cellulose foam is transformed into an open solid cellulose foam. The network of cellulose fibres is prevented from collapsing during drying. The solid cellulose foam will as a result have a shape that to a large extent corresponds to that of the wet cellulose foam. The dry content of the solid cellulose foam may be least 95 wt % as calculated based on the total weight of the solid cellulose foam. The shape and density of the solid cellulose foam is retained also in a non-confined state. The solid cellulose foam has an open cell structure, allowing air to occupy the pores within the foam. The solid cellulose foam can also be described as a porous material or a low-density material.

The following detailed description, and the examples contained therein, are provided for the purpose of describing and illustrating certain embodiments of the invention only and are not intended to limit the scope of the invention in any way.

In a first aspect, the present invention relates to a foldable solid cellulose foam.

In a second aspect, the present invention provides a method for producing said foldable solid cellulose foam.

Said solid cellulose foam may preferably be prepared from a cellulose foam composition comprising:
a) from 71-95 wt % cellulose fibres, as calculated on the total weight of solid content of the composition,
b) from 4 -24 wt % of a water-soluble thickener, as calculated on a total weight of solid content of the composition, and
c) at least two surfactants.

Cellulose fibres suitable for use in the present invention can originate from wood, such as softwood or hardwood, from leaves or from fibre crops (including cotton, flax and hemp). The cellulose fibres suitable for use in the present invention can also originate from regenerated cellulose such as rayon and Lyocell. The cellulose fibres suitable for use in the present invention may include lignin or hemicellulose or both, or the cellulose fibres may be free from lignin and hemicellulose. Preferably, the cellulose fibres originate from wood, more preferably the cellulose fibres are pulp fibres obtained by pulping processes which liberates the fibres from the wood matrix. Pulp fibres can be liberated by mechanical pulping, obtaining mechanical pulp such as thermos mechanical pulp (TMP) or chemo thermos mechanical pulp (CTMP), or by chemical pulping such as Kraft pulp or pulps obtained by the sulphite process, soda process or organosolv pulping process. More preferably, the cellulose fibres are pulp fibres liberated by chemical pulping processes. The different characteristic of each cellulose fibre will affect the properties of the final cellulose foam. A cellulose fibre is significantly longer than it is wide. Cellulose fibres can have a mean width of 0.01 to 0.05 mm. The fibre length of softwood can be from 2.5 to 4.5 mm, while hardwood can have a fibre length from 0.7 to 1.6 mm, and Eucalyptus from 0.7 to 1.5 mm. However, the fibre length can vary considerably with different growing place etc. The cellulose fibres in the cellulose foam disclosed herein can have a length from 0.1 mm to 65 mm, or from 0.1 mm to 10 mm, or from 0.5 mm to 65 mm, or from 0.5 mm to 10 mm, or from 0.5 mm to 7 mm.

The fibre lengths may provide different mechanical characteristics to the foam. Due to the length of fibres, they can entangle with each other and impart fibre to fibre interbonds that bring strength to the foam. The aspect ratio, i.e. the ratio of the fibre length to the fibre width, of the cellulose fibres in the cellulose foam according to the present invention can be at least 10, at least 25, at least 50, at least 75, or at least 100, which provides for preservation and stabilization of the foam structure during the drying procedure, making it possible to dry the wet cellulose foam with retained shape. The aspect ratio can be up to 6500, or preferably up to 2000.

The cellulose fibres may be modified to provide different properties to the final cellulose foam. For example, phosphorylated fibres or periodate oxidized fibres could also be used when producing a cellulose foam according to the present invention.

The cellulose fibres of the cellulose foam composition may be selected from wood pulp; regenerated cellulose fibres; and plant fibres, such as fibres from bamboo, cotton, hemp, flax, and jute.

Preferably, the cellulose fibres are selected from wood pulp, such as softwood pulp, hardwood pulp, chemical-thermomechanical pulp, and from dissolving pulp, or a combination of one or more of these.

More preferred, the cellulose pulp fibres are selected from softwood pulp, chemical-thermomechanical pulp, or dissolving pulp.

Most preferred, the cellulose pulp fibres are selected from softwood pulp, such as softwood kraft bleached pulp.

The water-soluble thickener may be present in an amount of from 4 -24 wt %, or from 5-20 wt %, as calculated on the total weight of solid content of the foam. The thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof.

The foam preferably comprises a mixture of at least two surfactants. One of the at least two surfactants is preferably a fast-acting surfactant that during preparation of the foam quickly settle at the air-water interphase during mechanical agitation, which contributes to the formation of a foam with a high density and a high viscosity and thus enables a free-standing foam. A suitable surfactant for this purpose is an anionic surfactant, preferably a low-molecular weight anionic surfactant. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The co-surfactant may be selected from high pKa fatty acids, such as from plant derived feedstock, e.g. tetradecanoic acid (myristic acid), sodium oleate, lauric acid, palmitic acid, and stearic acid; glucose based cosurfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. tween® (e.g. tween® 20, tween® 80 and tween® 85); and polyoxyethylene lauryl ethers, such as polyethylene glycol dodecyl ether, pentaethylene glycol monododecyl ether and octaethylene glycol monododecyl ether.

Said foam composition may preferably be prepared by a method comprising the steps of:
a) disintegrating cellulose fibres in water to obtain a slurry of cellulose fibres;
b) adding the thickener to the slurry obtained in a) to obtain a mixture of thickener and cellulose fibres in water;
c) adding the at least two surfactants to the mixture obtained in b) to obtain a fibre suspension;
d) aerating the suspension obtained in c) to obtain a wet foam,
wherein the wet foam comprises 10-38 wt % cellulose fibres, 0.5-10 wt % of the water-soluble thickener, and 0.1-2 wt % surfactants, as calculated on the total weight of the wet foam, and wherein the wet foam has a density of from 140-500 kg/m³ and a yield stress of from 40 to 400 Pa;
e) drying the wet foam obtained in d) to obtain a dried cellulose foam.

The wet foam may be dried without using a mould, i.e. the wet foam is free-standing and retains its shape during drying without the need of a mould.

The wet foam is homogenous and has a good stability due to a small bubble size (typically below 100 μm) obtained when aerating the mixture of cellulose fibres, thickener and surfactants. The wet foam does not flocculate during processing. The average bubble size is largely maintained during any subsequent processing or drying steps and the cellulose fibres remain well dispersed. The resulting solid cellulose foam obtained by drying the wet foam will be homogenous in structure, strong, have good mechanical properties, a smooth surface and no defects. In comparison, a wet cellulose foam with low stability has a larger average bubble size (i.e. typically above 100 μm) and the bubbles will coalesce faster during processing and drying such that larger bubbles are formed. In addition, the cellulose fibres will form clusters during processing and drying. This results in the wet foam collapsing during drying. The resulting solid cellulose foam will not have a homogenous structure and will also contain defects in the form of cavities resulting from the coalesced bubbles in the wet foam. Such a solid cellulose foam is, due to the defects, weak and has a rough surface.

Said dried cellulose foam obtained in step e) may be used as the solid cellulose foam in the present invention.

Said dried cellulose foam obtained in step e) may be obtained by a method comprising: depositing discrete units of a cellulose foam on a surface to obtain a first foam deposition, depositing a wet cellulose foam between the discrete units to obtain a subsequent foam deposition, and drying the wet foam to obtain a solid foam wherein discrete units of a foam are embedded in a foam matrix. Said solid cellulose foam may then be used as the solid cellulose foam of claim 1 and its dependent claims.

However, said solid cellulose foam may be prepared by other methods than the above described without departing from the scope of the present invention. For example, said solid cellulose foam may be prepared by a single deposition of a wet foam into any desired shape. Optionally, any suitable restriction means, such as a mould or a frame, may be used.

Said solid cellulose foam material may e.g. be prepared by depositing the foam composition on a forming portion of a conventional or, for the purpose suitably modified, paper machine for forming a foam web.

Production of a solid cellulose foam comprises different production steps, one of which is a drying step. During said drying step outside surfaces of said foam (top surface, lower surface, side surfaces) will get an outer layer that has different properties than a bulk portion of said foam comprising a more homogeneous and porous open-cell fibre network. Said outer layer has a higher density than a density of said bulk portion because the fibres are packed more tightly and are partly oriented differently. The bulk is highly porous, and even though the densified layer has a denser structure than the core, it is still porous. The outer layer is called a “densified layer” or “densified outer layer”. Said densified layer will provide improved mechanical stability and improved strength to the foam.

The densified layer is a very thin layer that is formed on the very outer surfaces of the cellulose foam during drying. The densified layer is made up of cellulose fibres that are mainly oriented in a two-dimensional plane (x-y-plane), while the fibres in the bulk of the cellulose foam comprises clusters of fibres oriented in a three-dimensional space with more empty space in between clusters. The two-dimensional structure of cellulose fibres in the densified layer transitions rapidly, but gradually, to the three-dimensional structure found in the bulk of the cellulose foam. The thin thickness of the densified layer implies that it practically does not affect the overall density of the cellulose foam.

Thanks to said densified layer having improved mechanical stability and providing strength to said foam, it may be preferred to orientate surfaces comprising said densified layer towards directions where extra stability may be needed.

The improved properties of said densified layer are used at positions of the product where they can contribute to the protective properties of said product. Although having a higher density, said densified layer is still highly porous and air permeable.

Said first aspect, said foldable solid cellulose foam comprising an upper surface and a lower surface, wherein at least one of said upper surface and said lower surface of said foldable solid cellulose foam comprising at least one cutting line of a predetermined depth of cut DC, wherein said at least one cutting line is arranged to partially cut through said cellulose foam, is now to be described in detail with reference to the accompanying figures.

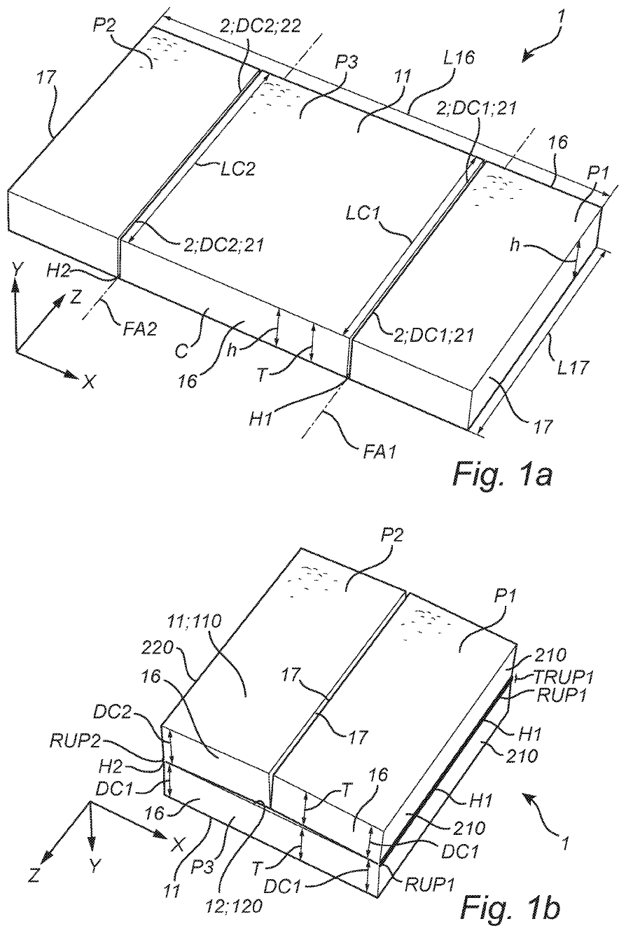

FIG. 1a and FIG. 1b show a first embodiment of said foldable solid cellulose-based foam 1 in an oblique side-view from above. In FIG. 1a, said cellulose foam is shown in an unfolded state, while in FIG. 1b said cellulose foam 1 is shown in a folded state.

Said foldable solid cellulose foam has a shape of a plank and comprises an upper surface 11 and a lower surface 12, two long side surfaces 16 and two short side surfaces 17.

Said side surfaces 16, 17 have a height h. Preferably, said height h corresponds to a thickness T of said solid cellulose foam 1. Said long side surfaces 16 and said short side surfaces 17 are rectangular surfaces 16, 17 defined by a respective length L16, L17 and said height h and wherein said respective length L16, L17 is longer than said height h.

According to the invention, said cellulose foam 1 comprises at least one cutting line 2 having a predetermined depth of cut DC and wherein said at least one cutting line 2 is arranged in a direction of said thickness T.

In the embodiment shown in FIG. 1a, said upper surface 11 comprises two cutting lines 2; a first cutting line 21 and a second cutting line 22 of a respective predetermined depth of cut DC1, DC2, wherein said two cutting lines are arranged to partially cut through said cellulose foam 1.

In the shown embodiment said cutting lines 21, 22 are arranged to run from one long side surface 16 to the other long side surface 16. Said cutting lines 21, 22 are further arranged parallel to said short side surfaces 17 of said cellulose foam 1. Said cutting lines 21, 22 have a respective length of cut LC1, LC2 equal to said length L17 of said short side surfaces 17 such that said cutting lines 21, 22 partly cut through also said long side surfaces 16 and to a same predetermined depth of cut DC1, DC2.

Said cutting lines 21, 22 are arranged to not be through-cuts of said foam 1. This means that said predetermined depth of cuts DC1, DC2 are less than said thickness T of said cellulose foam 1.

Said cutting lines 21,22 are arranged in said cellulose foam 1 such that said cutting lines 21, 22 cut through said upper surface 11 and cut further into a core C of said foam and in a direction towards said lower surface 12, and as earlier mentioned, in the thickness direction of said foam 1.

In FIG. 1a it is shown that said cutting lines 21, 22 are arranged to extend in a Y/Z-plane of a X/Y/Z-space. Said cutting lines 21, 22 are straight cutting lines that each create a flat cut in the foam 1.

Said cutting lines 21, 22 divide the cellulose foam 1 into three portions P1, P2, P3, wherein a first portion P1 is formed by said first cutting line 21 and one of the short side surfaces 17. A second portion P2 is formed by the second cutting line 22 and the other one of said short side surfaces 17, and a third portion P3 is formed between said first cutting line 21 and said second cutting line 22.

Since said cutting lines 21, 22 are arranged to not cut through said cellulose foam 1 but to terminate prior to reaching said lower surface 12, two remaining uncut portions RUP1, RUP2 (Shown in FIG. 1b) remain in the cellulose foam 1. Said two remaining uncut portions RUP1, RUP2 are located between where each of said cutting lines 21, 22 terminates, and the lower surface 12, and extending in said Y/Z-plane.

Each of said remaining uncut portions RUP1, RUP2 has a thickness TRUP1, TRUP2 (not shown) in the Y-direction that is equal to said thickness T of said cellulose foam minus said predetermined depth of cut DC1, DC2 of said cutting lines 21, 22.

Furthermore, each of said remaining uncut portions RUP1, RUP2 has an extension parallel with said length of cuts LC1, LC2 and extends from one of said long side surfaces 16 to the other of said long side surfaces 16.

Thanks to arranging said cutting lines 21, 22 to not cut through said cellulose foam 1 but to terminate prior to reaching said lower surface 12 and thereby leaving said remaining uncut portions RUP1, RUP2, said remaining uncut portions RUP1, RUP2 form a respective first and second hinge H1, H2 for said cellulose foam 1 to be folded around.

Said first portion P1 may be folded around said first hinge H1 and said second portion P2 may be folded around said second hinge H2.

Each of said hinges H1, H2 comprises a respective folding axis FA1, FA2 around which said cellulose foam 1 may be folded around. Said folding axes FA1, FA2 extend in the cellulose foam 1 in a Z-direction. In the embodiment shown in Fig la, said folding axes FA1, FA2 are parallel to said short side surfaces 16, 17 as well as to a length direction of said cutting lines 21, 22.

Preferably, said predetermined depth of cut DC of said at least one cutting line is 99% or less of said thickness T of said cellulose foam; preferably 80% or more, more preferred 90% or more, and most preferred 90-99% of said thickness T of said cellulose foam.

As mentioned above, in FIG. 1b said cellulose foam 1 is shown in a folded state. Said first portion P1 is folded around said first hinge H1 towards the lower surface 12 and said second portion P2 is folded around said second hinge H2 towards the lower surface 12. Said third portion P3 forms a bottom portion and said first and second portions P1, P2 form a top portion of the folded cellulose foam 1.

In the folded state, said cutting lines 21, 22 form two cutting surfaces, a first cutting surface 210 and a second cutting surface 220. Said cutting surfaces 210, 220 form new short side surfaces 17. For the sake of accuracy, it has to be pointed out that due to the folding of said cellulose foam 1, said short side surfaces 17 may now be longer than the folded long side surface 16.

For embodiments of the invention comprising two or more cutting lines, said cutting lines may have an equal predetermined depth of cut DC or different predetermined depth of cuts DC. In the embodiment shown in Fig. la the two cutting lines 21, 22 have equal predetermined depth of cuts DC1, DC2.

Said at least one cutting line is arranged to cut into said cellulose foam 1 at a cutting angle CA to said at least one of said upper surface 11 and lower surface 12. Which angle is chosen depends on the circumstances, e.g. on a shape of an object to be protected by said foldable solid cellulose foam. In FIGS. 1a-1b said cutting lines 21, 22 are arranged to cut into said cellulose foam 1 at a perpendicular cutting angle.

It may be preferred that at least said lower surface 12 comprises a densified outer layer 120. Said two one cutting lines 21, 22 are then arranged to not cut through said densified outer layer 120, or at least to cut through only a minor portion of said densified outer layer 120, such that said two remaining uncut portions RUP1, RUP2 comprise said densified outer layer forming said at least one hinge H, i.e. in this embodiment said two hinges H1, H2.

In some embodiments there is no clear, well-defined limit between said core C and said densified outer layer 110, 120. Instead, there is a gradual transition from said core C to said densified outer layer 110, 120 such that said core C gradually transitions to said densified outer layer 110, 120. For these embodiments said at least one cutting line 2 may possibly cut through just a portion of said transition from said core C towards said densified outer layer 110, 120 but is arranged to not cut through said densified outer layer 110, 120; or at least to cut through only a minor portion of said densified outer layer 110, 120.

In some embodiments it may be preferred that not only said lower surface 12 comprises said densified outer layer 120 but also that said upper surface 11 comprises a densified outer layer 110. In such embodiments, said cutting lines 21, 22 will cut through the densified outer layer 110 on the upper surface 11, but not through the densified outer layer 120 on said lower surface 12.

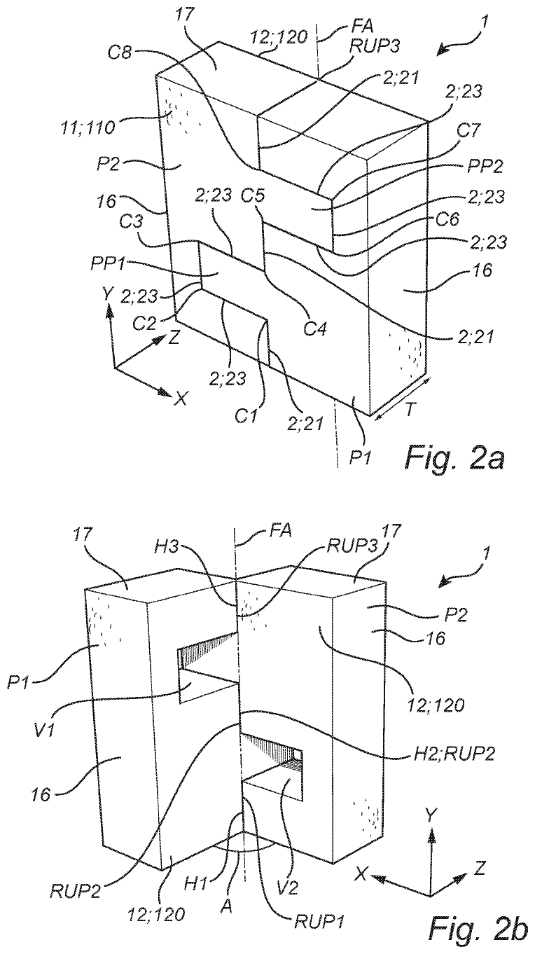

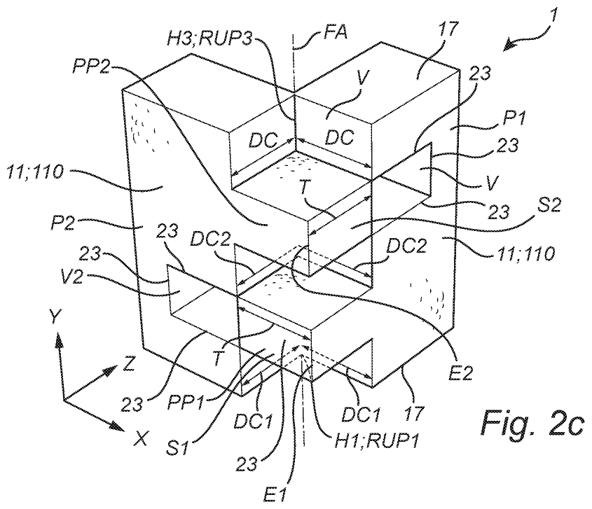

FIG. 2a shows a second embodiment of said foldable solid cellulose-based foam 1 in an oblique side-view. Said cellulose foam 1 is shown in an unfolded state.

What has been described regarding FIGS. 1a-1b also applies to FIGS. 2a-2c and will not necessarily be repeated in the forthcoming.

The cutting line 2 shown in FIG. 2a is arranged in said upper surface 11 and into said core C and further towards the lower surface 12. As can be seen said cutting line 2 is an angled cutting line 2 comprising eight perpendicular corners C1-C8.

Said cutting line 2 divide the cellulose foam 1 into two portions P1, P2, wherein a first portion P1 is formed by said first cutting line 2 and one of the long side surfaces 16. A second portion P2 is formed between said cutting line 2 and the other one of said long side surface 16. The wordings “long side surface” and “short side surface” may not necessarily mean that said long side surface is always longer than the short side surface. It may as well be the other way round depending on the dimensions of the cellulose foam 1.

Said cutting line 2 comprises six cutting line portions 23. All six cutting line portions 23 have a predetermined depth of cut DC that is equal to said thickness T of said cellulose foam. This means that said six cutting line portions 23 are through-going cutting lines 23. Three of said six through-going cutting lines 23 form a first protruding portion PP1 comprised in said first portion P1, while the other three of said six through-going cutting lines 23 form a second protruding portion PP2 comprised in said second portion P2. Each pair of said through-going cutting lines 23 separates the protruding portions PP1, PP2 from the cellulose foam 1 such that the protruding portions P1, P2 may be removable as will be further discussed below.

Said cutting line 2 further comprises three cutting line portions 21 arranged to partially cut through said cellulose foam 1 such that said three cutting line portions 21 have a predetermined depth of cut DC that is less than said thickness T of said cellulose foam 1. Three remaining uncut portions RUP1, RUP2, RUP3 are thereby formed between said three cutting line portions 21 and said lower surface 12. Each of said three remaining uncut portions RUP1, RUP2, RUP3 form a respective hinge H1, H2, H3 comprising a common folding axis FA for said cellulose foam 1 to be folded around.

In some embodiments, said lower surface 12 comprises a densified outer layer 120. Said three cutting line portions 21 arranged to partially cut through said cellulose foam 1 are in these embodiments arranged to extend from said upper surface 11 and in a direction towards said lower surface 12 into a core C between said upper and said lower surface 11, 12 and towards said densified outer layer 120 on said lower surface 12. Said three cutting line portions 21 are further arranged to not cut through said densified layer 120, but to terminate prior to said densified outer layer 120 such that said three remaining uncut portions RUP1, RUP2, RUP3 comprise said densified outer layer 120 wherein said three remaining uncut portions RUP1, RUP2, RUP3 and said densified outer layer 120 form said three hinges H1, H2, H3.

Thanks to a combination of hinges H1, H2, H3 and removable protruding portions PP1, PP2 said cellulose foam 1 is made foldable.

Said folding of the cellulose foam 1 is performed by folding either of the two portions P1, P2 around the folding axis FA by making use of said hinges H1, H2, H3. As discussed above, since said protruding portions PP1, PP2 are removably arranged by the through-going cutting lines 23, said first protruding portion PP1 will be removed from said second portion P2 and said second protruding portion PP2 will be removed from said first portion P1 when either of the two portions P1, P2 is folded around the folding axis FA.

FIG. 2b shows a folded state of said foldable cellulose foam 1. One or both of said first and second portions P1, P2 of the cellulose foam 1 has/have been folded to a folding angle A. In the shown embodiment, said folding angle A is 90° and said first and second portions P1, P2 together form a perpendicular corner that may be used as e.g. a corner protection.

In the folded state of the cellulose foam 1, said first and second protruding portion PP1, PP2 form an outside of said corner (best seen in FIG. 2c). Said corner comprises two edges, a first edge E1 and a second edge E2, wherein said first edge E1 is a part of said first protruding portion PP1 and said second edge E2 is a part of said second protruding portion PP2. Thanks to this aspect, said protruding portions PP1, PP2 and their respective edges E1, E2 contribute to stabilize said corner and to improve the mechanical properties of the corner, such as impact resistance.

This structural design of said corner allows to use the entire foldable cellulose foam, and there is no waste material in between.

As can be seen in FIGS. 2b-2c, said first protruding portion PP1 forms a corresponding void V2 in said second portion P2 of the foam 1, while said second protruding portion PP2 forms a corresponding void V1 in said first portion P1 when the cellulose foam 1 is in its folded state.

Said protruding portions PP1, PP2 each comprises a surface S1, S2 formed by the though-going cutting lines 23.

Said lower surface 12 of said cellulose foam 1 forms an inside of said corner and will face said corner of the product to be protected. An outside surface of said corner is formed by said upper surface 11 and said surfaces S1, S2 of said protruding portions PP1, PP2.

In preferred embodiments of the invention, at least one of said upper surface 11 and said lower surface 12 of said solid cellulose foam comprises a densified outer layer 110, 120.

In some embodiments, said at least one cutting line 2 is arranged to cut through one of said upper surface 11 and said lower surface 12 into said core C and all the way to—but not through—said densified outer layer 110, 120 of the other one of said at least one of said upper surface 11 and said lower surface 12 such that said at least one remaining uncut portion RUP is said densified outer layer 110, 120 forming said at least one hinge H. Said predetermined depth of cut DC may in these embodiments be formulated as the thickness T of said cellulose foam 1 minus a thickness of said densified outer layer 110, 120 of the other one of at least one of said upper surface 11 and said lower surface 12.

Preferably, both of said upper surface 11 and said lower surface 12 comprise said densified outer layer 110, 120.

Embodiments are conceivable wherein said at least one cutting line 2 is arranged to cut into said material at a cutting angle CA that is not perpendicular to said upper surface or said lower surface but is arranged to cut oblique. Said cutting angle CA may in these embodiments be less than 90° or greater than 90°.

It is to be understood that in embodiments wherein said at least one cutting line 2 is arranged oblique into said at least one of said upper surface 11 and said lower surface 12 and further into said foam 1, said predetermined depth of cut DC is a component of a vector of a cutting length of said oblique cutting line and whereby the component has the same direction as said thickness T (and most often said height h) of said foam.

Said at least one cutting line 2 may further be arranged in a vertical direction, or a horizontal direction, or a direction between a vertical direction or a horizontal direction on at least one of said upper surface 11 or lower surface 12. The direction to be chosen depends on the shape of the object to be protected by said foldable solid cellulose foam 1.

It is also to be understood that said at least one cutting line 2 is arranged to cut through at least one of said upper surface 11 and said lower surface 12 from one of said long side surfaces 16 to the other one of said long side surfaces 16, or from one of said short side surfaces 17 to the other one of said short side surfaces 17 such that the concerned side surfaces 16, 17 are also cut through to a same predetermined depth of cut DC as said predetermined depth of cut through said upper and or lower surface 11, 12.

Arranging said at least one cutting line 2 to run from one side surface 16, 17 to the opposite side surface 16, 17 and cut through said at least one of said upper or lower surface 11, 12 and said one side surface 16, 17 and said opposite side surface 16, 17, but to not cut through the other one of said upper or lower surface 11, 12, provides said cellulose foam 1 with at least one remaining uncut portion RUP running all the way from said one side surface 16, 17 and to said opposite side surface 16, 17 thereby providing said cellulose foam 1 with at least one hinge H. Said at least one hinge H thereby also running all the way from said one side surface 16, 17 and to said opposite side surface 16, 17. Said cellulose foam 1 is thereby made foldable around said at least one hinge H.

For embodiments wherein said at least one cutting line 2 is arranged to run from one long side surface 16 to the other long side surface 16, said at least one cutting line 2 is preferably arranged parallel to said short side surfaces 17 and has a cutting length LC equal to the length L17 of said short side surfaces 17.

For embodiments wherein said at least one cutting line 2 is arranged to run from one short side surface 17 to the other short side surface 17, said at least one cutting line 2 is preferably arranged parallel to said long side surfaces 16 and has a cutting length LC equal to the length L16 of said long side surfaces 16.

When said at least one cutting line 2 is arranged parallel with either of said long side surfaces 16 and short side surfaces 17, said at least one cutting line 2 meets a corner between said upper or lower surfaces 11, 12 and said long side surfaces 16 or short side surfaces 17 perpendicularly.

In some embodiments, two or more cutting lines 2 are arranged on at least one of said upper and said lower surface 11, 12.

Said foldable solid cellulose foam 1 may preferably comprise a flat surface.

Preferably, at least one of said upper and said lower surface 11, 12 is a flat surface wherein said at least one cutting line 2 is arranged on said flat surface.

It is to be understood that since said at least one cutting line 2 is arranged to run in a direction from one edge to an opposite edge of at least one of said upper surface and said lower surface 11, 12, said at least one cutting line 2 also cuts said at least one side surface 16, 17.

Said height h of said at least one side surface 16, 17 may, as earlier mentioned, be related to said thickness T of said foam 1.

Said height of said at least one side surface 16, 17 may be very small in relation to said upper and lower surface 11, 12. An example of a cellulose foam 1 having a small height in relation to an upper surface 11 and a lower surface 12 is a cellulose foam plank.

An example of a flat surface may be a surface of said solid cellulose foam plank.

In some embodiments, both of said upper surface 11 and said lower surface 12 of said cellulose foam 1 comprise at least one cutting line 2 of a predetermined depth of cut DC.

Said at least one cutting line 2 of said upper surface 11 and said at least one cutting line 2 of said lower surface 12 may have the same direction or have different directions.

It is further conceivable that at least one of said upper and said lower surface 11, 12 comprises at least two cutting lines 2 of different directions.

It is conceivable that said densified outer layer 110, 120 has a different thickness depending on which surface said densified outer layer 110, 120 is arranged on. It is further conceivable that said densified outer layer 110, 120 may have the same thickness irrespective of on which surface said densified outer layer 110, 120 is arranged on.

Said second aspect, the method for producing said foldable solid cellulose foam 1 material, is now to be described.

Said method comprises the steps of:
providing a solid cellulose foam 1 comprising an upper surface 11 and a lower surface 12;
arranging at least one cutting line 2 of a predetermined depth of cut DC into at least one of said upper surface 11 and said lower surface 12, whereby further arranging said at least one cutting line 2 to partially cut through said solid cellulose foam 1.

Cutting is performed by providing a cutting tool and arranging said cutting tool to be in contact with said at least one of said upper surface 11 and said lower surface 12. Said cutting tool is then forced into said at least one of said upper surface 11 and said lower surface 12 and further into said core C of said cellulose foam 1 thereby arranging said at least one cutting line 2, 21, 22 to partially cut through said cellulose foam 1.

Said cutting operation ends when said at least one cutting line 2 partially cuts through said solid cellulose foam 1 such that said predetermined depth of cut DC is less than a thickness T of said cellulose foam thereby arranging at least one remaining uncut portion RUP between said at least one cutting line 2 and the other one of said at least one of said upper surface 11 and said lower surface 12.

Said at least one remaining uncut portion RUP has a thickness TRUP that is equal to said thickness T of said cellulose foam 1 minus said predetermined depth of cut DC of said cutting line 2 wherein said at least one remaining uncut portion RUP forms at least one hinge H for said cellulose foam 1 to be folded around.

Said predetermined depth of cut DC of said at least one cutting line is arranged to be 99% or less of said thickness T of said cellulose foam, preferably 80% or more, more preferred 90% or more, and most preferred 90-99% of said thickness T of said cellulose foam 1.

Preferably, at least one of said upper surface or said lower surface 11, 12 of said solid cellulose foam 1 is arranged to comprise a densified outer layer 110, 120.

Said cutting tool further arranges said at least one cutting line 2 to extend from one of said upper surface 11 and said lower surface 12 into a core C between said upper and said lower surface 11,12 and towards said densified outer layer 110, 120 on the other one of said upper surface 11 and said lower surface 12; and arranging said at least one cutting line 2 to not cut through said densified layer 110, 120, but to terminate prior to said densified layer 110, 120 such that said at least one remaining uncut portion RUP comprises said densified outer layer 110, 120. Said at least one remaining uncut portion RUP and said densified outer layer 110, 120 thereby forming said at least one hinge H. Said at least one cutting line 2 is arranged to be a straight cutting line, a curved cutting line, an angular cutting line comprising at least one angle, a cutting line of an irregular shape, or any combination thereof.

Said at least one cutting line 2 may further be arranged to comprise at least one portion having a predetermined depth of cut DC that is less than said thickness T of said cellulose foam 1, and at least one portion having a predetermined depth of cut DC that is equal to said thickness T of said cellulose foam 1.

Said foldable solid cellulose foam 1 may be arranged to comprise at least one cutting line 2 having a predetermined depth of cut DC that is equal to said thickness T of said cellulose foam.

Said at least one cutting line 2 arranged to cut through said foam 1 may be arranged to be a straight cutting line, a curved cutting line, an angular cutting line comprising at least one angle, a cutting line forming a closed loop, a cutting line of an irregular shape, or any combination thereof.

Said method further comprises arranging said at least one cutting line 2 to partially cut into said solid cellulose foam 1 in a direction that is perpendicular to at least one of said upper surface 11 and said lower surface 12.

In some embodiments said at least one cutting line 2 is arranged to partially cut into said solid cellulose foam 1 at an angle to said upper surface 11 or said lower surface 12, wherein said angle is less than 90° or greater than 90°.

In other embodiments of the method said at least one cutting line 2 is arranged to cut oblique into said foam 1. Said at least one cutting line 2 cuts into said foam 1 at a cutting angle CA to said upper surface or said lower surface, wherein said cutting angle CA is less than 90° or greater than 90°.

Said at least one cutting line 2 is arranged to run in a direction from one edge to an opposite edge of said respective upper surface or lower surface 11, 12; said at least one cutting line thereby forming an angle EA with said edge.

In some embodiments, said method further comprises arranging at least one cutting line 2 of a predetermined depth of cut DC into both of said upper surface 11 and said lower surface 12. It is to be understood that said predetermined depth of cut DC may be the same on both sides or may be different on different surfaces 11, 12 of said foam 1. It is also to be understood that said at least one cutting line 2 of said upper surface 11 and said at least one cutting line 2 of said lower surface 12 may be arranged to have same directions or to have different directions.

Said method further comprises arranging at least one of said upper surface 11 or said lower surface 12 of said solid cellulose foam 1 to comprise said densified outer layer 110, 120; and preferably arranging both of said at least one of said upper surface 11 or said lower surface 12 to comprise said densified outer layer 110, 120.

In some embodiments, said method comprises arranging said at least one cutting line 2 to cut through one of said upper surface 11 and said lower surface 12 into said core C and all the way to-but not through-said densified outer layer 110, 120 of the other one of at least one of said upper surface 11 and said lower surface 12 such that said at least one remaining uncut portion RUP is said densified outer layer 110, 120 forming said at least one hinge H. Said predetermined depth of cut DC may in these embodiments be formulated as the thickness T of said cellulose foam 1 minus a thickness of said densified outer layer 110, 120 of the other one of at least one of said upper surface 11 and said lower surface 12.

### Materials And Material Properties

The cellulose fibres comprised in said solid cellulose foam are preferably selected from wood pulp; regenerated cellulose fibres; and plant fibres; preferably selected from softwood pulp, chemi-thermo mechanical pulp (CTMP) and dissolving pulp or a combination thereof.

Said solid cellulose foam preferably comprises:
a)) from 71-95 wt % cellulose fibres, as calculated on the total weight of solid content of said foam,
b) from 4 -24 wt % of a water-soluble thickener, as calculated on the total weight of solid content of said foam, and
c) at least two surfactants.

A density of said solid cellulose foam may be in the interval of 10-80 kg/m³, preferably 10-60 kg/m³ and more preferred 20-50 kg/m³.

At least one of said upper surface or said lower surface of said solid cellulose foam comprises a densified outer layer. Preferably, both said upper and said lower surface comprise said densified outer layer.

Said cellulose foam may have a thickness in an interval of 5-200 mm, more preferred 10-100 mm, or 10-50 mm.

An example of a conceivable dimension is a solid cellulose foam plank having a thickness of 40-60 mm, preferably around 50 mm.

Said dimensions only serve as examples and should not be seen as limiting the inventive product to said dimensions.

Said foldable solid cellulose foam may comprise compressed regions and through-cuts creating through-going holes.

Volumes of said through-cuts contribute to a housing for enclosing said product while partial cuts define surfaces which surfaces are then pressed whereby compressed regions are formed. Volumes of said compressed regions also contribute to a housing for goods to be packed and protected. Hence, arranging a housing in said solid cellulose foam causes no waste material.

Said partial cuts allow the product to be perfectly positioned and adds crucial extra protection in the packaging. Pressed details of said solid cellulose foam ensure correct positioning of the heaviest and/or most fragile parts of said goods and ensures that they are kept in place.

Compressing well defined portions of said solid cellulose foam to compressed materials of higher density, increase the stiffness and resilience of the solid cellulose foam in those portions. This provides means for keeping the product in place within the protective packaging insert.

Sections of said cellulose foam plank may be folded towards said product such that cut out or compressed portions of the solid cellulose foam plank come in a direct contact with said product. The very good cushioning ability of said solid cellulose foam plank efficiently shelters said product; said cut out or compressed portions fixedly arranged on said substrate help to position the goods during insertion and give extra protection.

At least one of said upper surface and lower surface may be a curved surface.

Said wordings “long side surface” and “short side surface” are only exemplifying wordings used in relation to the figures. It is to be understood that said at least one cutting line may be arranged in a direction parallel or substantially parallel or at an angle with either of said long side surfaces and said short side surfaces.

As will be understood by those skilled in the present field of art, numerous changes and modifications may be made to the above described and other embodiments of the present invention, without departing from the scope of the present invention as defined in the appending claims.

It should be noted that the above described aspects may be the subject for its own protection, as such in a separate divisional application. Hence, it is foreseen that this aspect of the invention may require a protection by its own, e.g. since it may be applicable per se also in other concepts than that defined by the independent claim in this application.

1. A foldable solid cellulose foam, wherein said foldable solid cellulose foam comprises:
an upper surface, and
a lower surface;
wherein at least one of said upper surface and said lower surface of said foldable solid cellulose foam comprises at least one cutting line of a predetermined depth of cut, and
wherein said at least one cutting line is arranged to partially cut through said foldable solid cellulose foam.

2. The foldable solid cellulose foam according to claim 1, wherein said predetermined depth of cut is less than a thickness of said foldable solid cellulose foam between said upper surface and said lower surface.

3. The foldable solid cellulose foam according to claim 1, further comprising:
two long side surfaces, and two short side surfaces, and
wherein said at least one cutting line is arranged to also cut said two long side surfaces or said two short side surfaces.

4. The foldable solid cellulose foam according to claim 1, wherein one of said upper surface and said lower surface comprises the at least one cutting line,
wherein at least one remaining uncut portion is located between said at least one cutting line and the other of said upper surface and said lower surface, and
wherein said at least one remaining uncut portion forms at least one hinge for said foldable solid cellulose foam to be folded around.

5. The foldable solid cellulose foam according to claim 1, wherein said predetermined depth of cut of said at least one cutting line is 99% or less of said thickness of said foldable solid cellulose foam.

6. The foldable solid cellulose foam according to claim 1, wherein at least one of said upper surface and said lower surface of said foldable solid cellulose foam comprises a densified outer layer.

7. The foldable solid cellulose foam according claim 6, wherein said at least one cutting line (2) is arranged to extend from one of said upper surface and said lower surface into a core between said upper surface and said lower surface and towards said densified outer layer on the other one of said upper surface and said lower surface;
wherein said at least one cutting line is arranged to not cut through said densified layer such that at least one remaining uncut portion comprises said densified outer layer.

8. The foldable solid cellulose foam according to claim 1, wherein said at least one cutting line is a straight cutting line, a curved cutting line, an angular cutting line comprising at least one angle, a cutting line of an irregular shape, or any combination thereof.

9. The foldable solid cellulose foam according to claim 1, wherein said at least one cutting line comprising at least a first portion having a predetermined depth of cut that is less than said thickness of said foldable solid cellulose foam and at least a second portion having a predetermined depth of cut that is equal to said thickness of said foldable solid cellulose foam.

10. The foldable solid cellulose foam according to claim 1, wherein said at least one cutting line is arranged to partially cut into said foldable solid cellulose foam in a direction that is perpendicular to said at least one of said upper surface and said lower surface.

11. The foldable solid cellulose foam according to claim 1, wherein a density of said foldable solid cellulose foam is between 10-80 kg/m³,

12. The foldable solid cellulose foam according to claim 1, wherein said foldable solid cellulose foam comprises:
a) from 71-95 wt % cellulose fibres, as calculated on a total weight of solid content of said foldable solid cellulose foam, b) from 4 -24 wt % of a water-soluble thickener, as calculated on the total weight of solid content of said foldable solid cellulose foam, and c) at least two surfactants.

13. A method for producing a foldable solid cellulose foam, said method comprising the steps of:
providing a solid cellulose foam comprising an upper surface and a lower surface;
arranging at least one cutting line of a predetermined depth of cut into at least one of said upper surface and said lower surface, whereby further arranging said at least one cutting line to partially cut through said solid cellulose foam.

14. The method according to claim 13, wherein said predetermined depth of cut is less than a thickness of said solid cellulose foam between said upper surface and said lower surface.

15. The method according to claim 13, wherein one of the upper surface and the lower surfaces comprises the at least one cutting line, and the method further comprising:
arranging at least one remaining uncut portion located between said at least one cutting line and the other of said upper surface and said lower surface,
wherein said at least one remaining uncut portion forms at least one hinge for said solid cellulose foam to be folded around.

16. The method according to claim 13, wherein said predetermined depth of cut of said at least one cutting line is 99% or less of said thickness T of said solid cellulose foam.

17. The method according to claim 13, further comprising:
arranging at least one of said upper surface or said lower surface of said solid cellulose foam to comprise a densified outer layer.

18. The method according to claim 17, wherein said at least one cutting line extends from one of said upper surface and said lower surface into a core between said upper surface and said lower surface and towards said densified outer layer on the other one of said upper surface and said lower surface, and
wherein said at least one cutting line does not cut through said densified outer layer such that at least one remaining uncut portion comprises said densified outer layer.

19. The method according to claim 13, wherein said at least one cutting line is a straight cutting line, a curved cutting line, an angular cutting line comprising at least one angle, a cutting line of an irregular shape, or any combination thereof.

20. The method according to claim 13, wherein said at least one cutting line comprises at least a first portion having a predetermined depth of cut that is less than said thickness of said solid cellulose foam, and at least a second portion having a predetermined depth of cut that is equal to said thickness of said solid cellulose foam.

21. The method according to claim 13, wherein said at least one cutting line partially cuts into said solid cellulose foam in a direction that is perpendicular to at least one of said upper surface and said lower surface.

22. The method according to claim 13, wherein said at least one cutting line partially cuts into said solid cellulose foam at an angle to said upper surface or said lower surface, wherein said angle is less than 90° or greater than 90°.

23. The method according to claim 13, wherein a density of said solid cellulose foam between 10-80 kg/m³.

24. The method according to claim 13, wherein said solid cellulose foam comprises:
a) from 71-95 wt % cellulose fibres, as calculated on a total weight of solid content of said solid cellulose foam,
b) from 4 -24 wt % of a water-soluble thickener, as calculated on the total weight of solid content of said solid cellulose foam, and
c) at least two surfactants.
